(19) United States
(12) Patent Application Publication
(10) Pub. No.: US 2026/0055303 A1
(43) Pub. Date: Feb. 26, 2026

(54) WEATHERPROOF REPAIR AND MULTIPURPOSE ADHESIVE TAPE

(71) Applicant: Shurtape Technologies, LLC, Hickory, NC (US)

(72) Inventors: Mir QUDDUS, Goldsboro, NC (US); Amy Randall, Granite Falls, NC (US); Khaled El-Tahlawy, Raleigh, NC (US)

(21) Appl. No.: 18/809,721

(22) Filed: Aug. 20, 2024

(51) Int. Cl. C09J 7/29; C09J 7/38

(52) U.S. Cl. CPC C09J 7/29; C09J 7/385; C09J 2203/37

(57) ABSTRACT

An adhesive tape having a combination of film rheology and adhesive to provide repositionability and conformability to a substrate as well as having other desirable attributes including, but not limited to, weatherproof, chemical resistance, impact resistance, and puncture depth. The adhesive tape is particularly suited for use as a repair and multipurpose adhesive tape, as well as a flashing tape.

### FIELD OF THE INVENTION

The present invention relates to adhesive tape, more particularly to an adhesive tape having weatherproof properties for repair and multipurpose use.

### BACKGROUND OF THE INVENTION

Adhesive tapes are commonly manufactured and sold for household and commercial use. Although certain adhesive tapes may be desirable for a limited and/or specialized purpose, there are many instances when a user wants or needs to be able to reach for a multipurpose tape and use for a multitude of end uses. However, there are also known disadvantages with many of such tapes. The tapes may be lacking in performance characteristics for a given end use application. Also, certain of these adhesive tapes may not be environmentally friendly. For example, an adhesive tape with a rubber-based adhesive tape, depending upon the physical construction of the tape, may not adhere to an irregular substrate as strongly over time.

Other adhesive tapes may only operate in a limited temperature range such that the adhesive tapes have a narrow service temperature range. As a result, the adhesive tape may have performance limitations in extreme temperature conditions. For example, the adhesive tape may be too soft at high temperatures and too rigid and brittle at very cold temperatures. Such tapes may also lack flexibility such as when exposed to cold temperatures.

Another common problem with existing adhesive tapes is in regard to application to surfaces. Many such tapes are difficult to stick to rough or uneven surfaces. In some instances, for example, a primer is required for an adhesive tape to stick to an irregular surface such as in the case of an adhesive tape containing a butyl adhesive. Conformability of building tapes plays a critical role in their performance, especially when adhering to irregular, textured, or complex surfaces. A non-conformable or stiff tape can result in poor adhesion, leading to gaps, wrinkles, and a higher risk of air and water leaks. These tapes are difficult to apply on intricate surfaces such as corners and curves, often requiring additional time, effort, and tools, which increases labor costs and the likelihood of installation errors. Additionally, their inability to stretch or flex makes them unsuitable for high-movement areas, leading to premature seal failure due to structural shifts. From an aesthetic standpoint, non-conformable tapes can create visible imperfections, detracting from the overall appearance and potentially necessitating costly rework to address both performance and visual issues. The application of building tapes faces significant challenges at cold temperatures, particularly around 0° F. Butyl rubber tapes have a narrow application window, between 30° F. and 110° F., and their limited applicability at lower temperatures puts them at a disadvantage in cold-weather environments. This restricts the usability of butyl tapes in low-temperature applications, potentially compromising performance and long-term durability.

There is also an issue with workability of the adhesive tape and integrity of the adhesive of such tapes under varying weather conditions. For example, many such adhesive tapes become messy and stick to themselves and, thus, are unable to be self-wound. For some adhesive tapes containing butyl, a strong solvent can dissolve the butyl (if exposed) since butyl-containing adhesive is solvent based resulting in a negative impact on the performance of the adhesive tape.

Puncture resistance and nail sealability are also an issue with many adhesive tapes, particularly those commonly used in the building and construction industries. The term “nail-sealable” is commonly used in the building industry in regard to how upon puncturing the tape with a nail or other similar sharp object, the tape conforms or closely surrounds the nail to seal the puncture or hole in the tape. Many existing tapes have difficulty in achieving puncture resistance and desirable nail sealability.

Some adhesive tapes degrade when exposed to ultraviolet (UV) light over extended periods. This degradation can reduce the effectiveness and lifespan of the adhesive tapes, especially when used in areas exposed to sunlight. Adhesive tapes can also suffer from thermal degradation when exposed to high temperatures over time. This degradation can manifest in several ways including loss of adhesion, chemical breakdown, and outgassing. At elevated temperatures, the adhesive may soften excessively, leading to a reduction in bond strength. This softening can cause the tape to slip, slide, or peel away from the substrate. Prolonged exposure to heat can cause the chemical components of the adhesive to break down, leading to a permanent loss of adhesive properties. This can result in the tape becoming brittle, chalky, or completely losing its stickiness. At elevated temperatures, some adhesives may release volatile components, leading to outgassing. This can create bubbles under the tape or cause the adhesive to lose mass, both of which degrade the bond.

Some adhesive tapes are too thick or bulky, making them difficult to use in tight spaces or causing them to stand out visually, which may not be desirable in certain applications.

Thus, there is a need for an adhesive tape that can be used for multiple purposes and that provides more desirable performance under a variety of weather conditions and with a wider range of service temperatures than existing adhesive tapes.

### SUMMARY OF THE INVENTION

The adhesive tape of the invention seeks to overcome the disadvantages with other adhesive tapes and to provide more desirable performance under a variety of weather conditions and with a wider range of service temperatures than such adhesive tapes. The adhesive tape of the invention achieves these results while being self-wound and repositionable.

The adhesive tape of the invention employs a unique combination of adhesive and film rheology in order to achieve the desired performance as a weatherproof repair and multipurpose adhesive tape in many applications including, but not limited to, do-it-yourself (DIY) projects as well as building and construction applications. The adhesive tape of the invention has a multitude of desirable properties including repositionability, conformability, impact resistance and excellent adhesion to irregular surfaces, among others.

In an aspect of the invention, the adhesive tape comprises: a backing layer; an adhesive layer on the backing layer; and an optional liner/release layer on the adhesive layer; wherein the backing layer comprises a film which resists penetration by having an impact resistance >5.5 lb force and a puncture depth of >3 inches. The adhesive of the adhesive layer, which in a preferred aspect may comprise an acrylic, is combined with the film having these physical properties.

In an aspect of the invention, the adhesive tape comprises: a backing layer, an adhesive layer on the backing layer, and an optional liner on the adhesive layer, wherein the backing layer comprises a film having an elongation and a modulus in a relationship as set forth in equation (1):

$$y = mx + b \qquad equation ( 1 )$$

wherein
m is slope,
b is y-intercept,
x is a normalized elongation (%/mil) as defined by x₁ and x₂,
wherein
x₁ (%/mil) is at least 180 to 1400;
x₂ (%/mil) is at least 180 to 1400; and
y is a normalized modulus (psi/mil) having a range of y_{MIN} to y_{MAX}
wherein

$${y}_{MIN} = - 21432.4 + {1204}_{{X}_{1}}$$

$${y}_{MAX} = - 17020.6 + {1204}_{{X}_{2}} .$$

The adhesive of the adhesive layer, which in a preferred aspect may comprise an acrylic, is combined with the film having this physical property relationship.

Further areas of applicability of the present invention will become apparent from the detailed description provided hereinafter. It should be understood that the detailed description and specific examples, while indicating the preferred embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings, which are not necessarily to scale, wherein:

FIG. 1 is an illustration of an adhesive tape in accordance with the present invention.

FIG. 2 is a graphical illustration of the relationship between normalized modulus (psi/mil) and normalized elongation (%/mil) as set forth in the examples.

FIG. 3 is a graphical illustration of a regression analysis of normalized modulus (y-axis) versus normalized elongation (x-axis) as set forth in the examples.

FIG. 4 is a graphical illustration of the relationship between normalized impact resistance (y-axis) and normalized modulus (x-axis) as set forth in the examples.

FIG. 5 is a graphical illustration of the relationship between normalized puncture depth (y-axis) and normalized modulus (x-axis) as set forth in the examples.

FIG. 6 is a graphical illustration of the relationship between normalized pliability failure time (y-axis) and normalized modulus (x-axis) as set forth in the examples.

FIG. 7 is a graphical illustration of the relationship between hydrostatic head force (y-axis) and normalized modulus (x-axis) as set forth in the examples.

FIG. 8A is an illustration of a curvature conformity test conducted using a U-shaped fixture as set forth in the examples.

FIG. 8B is a graphical illustration of the relationship between tape conformity (y-axis) and normalized modulus (x-axis) as set forth in the examples.

### DETAILED DESCRIPTION OF THE INVENTION

The following description of the embodiments of the present invention is merely exemplary in nature and is in no way intended to limit the invention, its application, or uses. The following description is provided herein solely by way of example for purposes of providing an enabling disclosure of the invention, but does not limit the scope or substance of the invention.

Further, the term “or” as used in this disclosure and the appended claims is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form. Throughout the specification and claims, the following terms take at least the meanings explicitly associated herein, unless the context dictates otherwise. The meanings identified below do not necessarily limit the terms, but merely provide illustrative examples for the terms. The meaning of “a,” “an,” and “the” may include plural references, and the meaning of “in” may include “in,” “at,” and/or “on,” unless the context clearly indicates otherwise. The phrase “in one embodiment,” as used herein does not necessarily refer to the same embodiment, although it may.

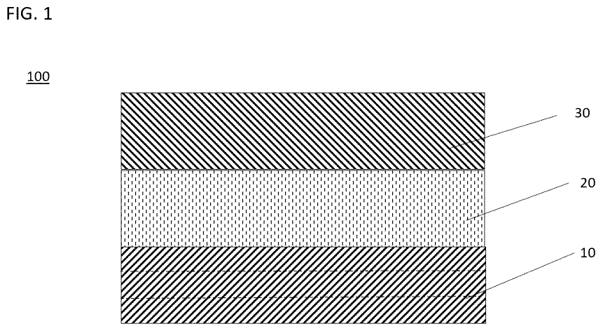

Referring to the figures, FIG. 1 is an illustration of an adhesive tape 100 in accordance with aspects of the invention. As shown, adhesive tape 100 comprises a backing layer 10, an adhesive layer 20 present on the backing layer, and an optional liner/release layer 30 present on the adhesive layer. The adhesive tape is repositionable. The adhesive tape is self-wound.

The adhesive tape is particularly suitable for use as a weatherproof repair and multipurpose adhesive tape for many applications including do-it-yourself (DIY) projects as well as building and construction applications. Among the characteristics of the adhesive tape that make it desirable for these purposes are the following.

The adhesive tape of the invention is at least initially repositionable, which among other things has the added advantage that it can be applied faster and generates less waste. The adhesive tape is more conformable such as around corners and prevents material build-up. The adhesive tape can be installed in a temperature range of zero Fahrenheit (F) to 150 F. The service temperature of the adhesive tape is in a range of −40 F to 240 F.

The adhesive tape has better adhesion to more substances OSB, wood, vinyl, poly sheathing, plastic, metal, glass, galvanized pipe, foam, copper pipe, ceramic, rubber, neoprene, HDPE, concrete, masonry and gypsum, and does not require a primer which can save waste and expense. The adhesive of the invention has improved compatibility with sealants and caulking, for example, to PVC window flanges. The adhesive tape is UV resistant, weatherproof, and chemical resistant.

In another aspect of the invention, the adhesive tape can be sustainable, for example, when the adhesive tape comprises an ultraviolet (UV) or radiation cured (via electron beam) adhesive, more preferably a UV or radiation cured acrylic adhesive, even more preferably a solventless UV or radiation cured acrylic adhesive. The UV curing eliminates solvent chemistry, thermal ovens, afterburners, air pollutants and greenhouse gasses. It also reduces energy consumption and carbon footprint, fast line speeds in a small footprint allows for instant cure, allows processing of thermally sensitive materials, and overall increased performance and aesthetical properties in a quicker time frame.

These desirable performance properties of the adhesive tape are achieved as a result of a unique and synergistic combination of adhesive and film rheology.

In an aspect of the invention, the adhesive tape performance is achieved by the combination of adhesive in the adhesive layer with a film having an impact resistance >5.5 lb force and a puncture depth of >3 inches in the backing layer. The adhesive tape performance can be achieved with the combination of an acrylic adhesive with a film having an impact resistance >5.5 lb force and a puncture depth of >3 inches.

It is also possible to achieve the adhesive tape performance by combining the adhesive with a film having an elongation and a modulus in a relationship as set forth in equation (1):

$$y = mx + b \qquad equation ( 1 )$$

wherein
m is slope,
b is y-intercept,
x is a normalized elongation (%/mil) as defined by x₁ and x₂,
wherein
x₁ (%/mil) is at least 180 to 1400;
x₂ (%/mil) is at least 180 to 1400; and
y is a normalized modulus (psi/mil) having a range of y_{MIN} to y_{MAX}
wherein

$${y}_{MIN} = - 21432.4 + {1204}_{{X}_{1}}$$

$${y}_{MAX} = - 17020.6 + {1204}_{{X}_{2}} .$$

This relationship between modulus and elongation of the film provides a rheologic performance window that achieves synergistic results when combined with the adhesive.

The adhesive of the adhesive tape can be a pressure sensitive adhesive. In a preferred aspect of the invention, the adhesive comprises an acrylic. The acrylic adhesive may be UV cured, radiation cured, or a combination thereof.

The construction of the backing layer may comprise a plastic film or polymeric material, an elastomeric material, and a combination thereof. The backing material is preferably multilayer. For example, the backing material may be three to five layers. In an aspect of the invention, the backing layer comprises a film with at least two skins and one core. The backing layer may comprise distinct elastomeric and plastic/polymeric components in each layer. The backing layer may also be embossed.

In an aspect of the invention, the adhesive tape has a total thickness in a range of 6 to 23 mils. The backing thickness is in a range of 3 to 15 mils. The adhesive thickness is in a range of 3 to 8 mils.

As indicated above, the adhesive tape is suitable as a weatherproof repair and multipurpose tape. Among such other purposes is that the adhesive tape is suitable for use as a flashing tape, for example, for use in building and construction. The adhesive tape has improved nail sealabilty as compared to other flashing tapes. Self-healing around nails and protrusions thereby creates a waterproof seal.

### EXAMPLES

Rheology experiments were conducted to test material performance of the film of the adhesive tape of the invention as compared to other commercially available films used in adhesive tapes used for similar purposes. Tests were also conducted to test tape design performance. The samples evaluated in each of the examples were:

| | | | Film | Adhesive | Tape |
|---|---|---|---|---|---|
| | | | Thickness | Thickness | Thickness |
| Sample | Adhesive | Film | Range | Range | Range |
| ID | Type | Composition | (mil) | (mil) | (mil) |
| A | Acrylic | 3 layer: | 4-6 | 2-5 | 6-11 |
| | | PO/EL/PO | | | |
| E | Acrylic | 3 layer: | 4-6 | 2-5 | 6-11 |
| | | PO/PO/PO | | | |
| F | Acrylic | 3 layer: | 4-6 | 2-5 | 6-11 |
| | | PO/PO/PO | | | |
| G | Acrylic | 3 layer: | 4-6 | 2-5 | 6-11 |
| | | PO/PO/PO | | | |

PO = polyolefin; EL = elastomeric

### Example 1—Rheology: Strong Correlation Between Elongation and Modulus

Tensile tests were performed using ASTM D3759 (per AAMA 711-22) on the film of each sample using an MTS tensile tester. The samples, each with dimensions of 1 inch by 1 inch, were subjected to a controlled force at a crosshead speed of 2 inches per minute. The tests measured tensile stress, percentage elongation and modulus for each sample, and a stress (lbf/in)-strain curve was generated for the film samples.

The data on the mechanical properties resulting from the tests conducted on the film of each sample is set forth in Table 1.

TABLE 1

| | Impact | | | | Puncture |
|---|---|---|---|---|---|
| Sample | Resistance | Penetration | Elongation | Modulus | Depth |
| ID | (lbf) | (Yes/No) | (%) | (psi) | (in) |
| A | 5.70 | No | 973.80 | 6088 | 4.44 |
| E | 5.10 | Yes | 1656.80 | 78067 | 2.36 |
| F | 2.90 | Yes | 1007.10 | 53158 | 2.11 |
| G | 2.60 | Yes | 1176.10 | 55856 | 1.16 |

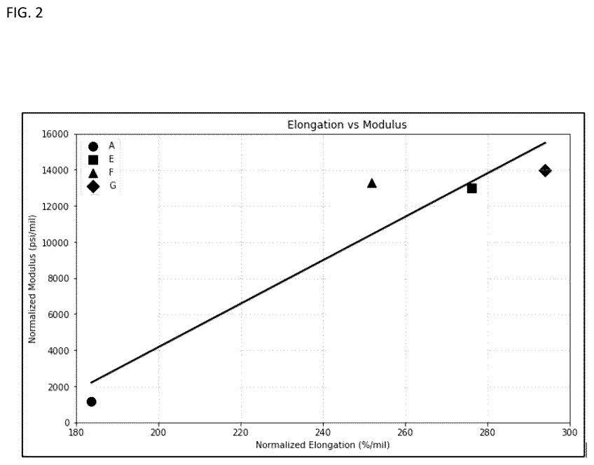

FIG. 2 illustrates the relationship between normalized modulus (psi/mil), and normalized elongation (%/mil) for Samples A, E, F, and G. The data indicated a positive correlation, suggesting that as normalized elongation increases, normalized modulus also increases. Sample A showed the lowest normalized modulus and elongation, while Sample G exhibited the highest values for both metrics. This trend suggested that samples with higher elongation also tend to have a higher modulus, indicating greater stiffness and strength. The data demonstrated a strong positive correlation, with a correlation coefficient of 0.95 and a p-value of 0.054, which suggested a strong statistical significance.

### Example 2—Rheology: Strong Correlation Between Elongation (Extrapolated) and Modulus

Tensile tests were performed using ASTM D3759 (per AAMA 711-22) on each sample using an MTS tensile tester. The samples, each with dimensions of 1 inch by 1 inch, were subjected to a controlled force at a crosshead speed of 2 inches per minute. The tests measured tensile strength, percentage elongation, and modulus for each sample. A stress (lbf/in)-strain (in) curve was generated for the film samples.

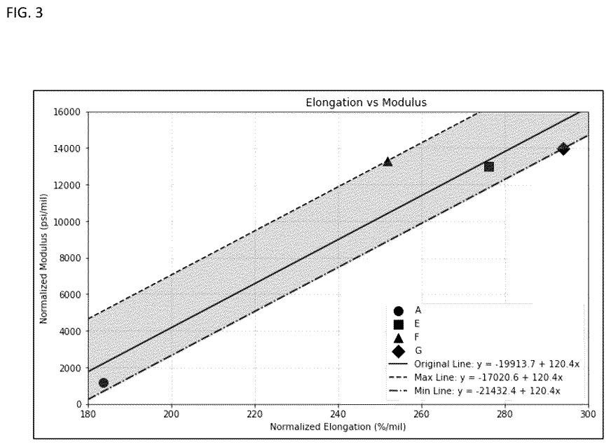

The stress-strain data curve was used to conduct a regression analysis. FIG. 3 is a graphical illustration of a regression analysis of normalized modulus (y-axis) versus normalized elongation (x-axis) for Samples A, E, F, and G. The original line represents the regression line, with the equation y=−19913.7+120.4xy=−19913.7+120.4xy=−19913.7+120.4x. The shaded area between the dashed lines indicates the range of variation around this regression line, defined by the maximum and minimum possible lines. The max line follows y=−17020.6+120.4xy−17020.6+120.4xy=−17020.6+120.4x, and the min line follows y=−21432.4+120.4xy=−21432.4+120.4xy=−21432.4+120.4x.

TABLE 2

| | Original | | Min | |
|---|---|---|---|---|
| x | Line | Max Line | Line | Range |
| 180 | 1755.7 | 4648.8 | 237 | 4411.8 |
| 200 | 4163.4 | 7056.5 | 2644.7 | 4411.8 |
| 220 | 6571.1 | 9464.2 | 5052.4 | 4411.8 |
| 240 | 8978.9 | 11872 | 7460.2 | 4411.8 |
| 260 | 11386.6 | 14279.7 | 9867.9 | 4411.8 |
| 280 | 13794.3 | 16687.4 | 12275.6 | 4411.8 |

The data demonstrated a strong positive correlation, with a correlation coefficient of 0.95 and a p-value of 0.054, which suggests a strong statistical significance.

### Tape Properties

### Example 3—Strongly Correlated with Impact Resistance

The Spencer Impact Test (ASTM D3420-94) was utilized to assess the impact resistance of the samples (sample size 3.5″). This test involves using a weighted pendulum and Air clamp assembly (min 60 PSI) which is released from a specified height to strike the test specimen. The energy absorbed by the material upon impact is measured, providing an indication of its toughness and ability to withstand sudden forces. The pendulum's height is calibrated to ensure consistent energy delivery, and the test results help in evaluating the material's durability under impact conditions.

The data on the mechanical properties resulting from the tests conducted on the films is set forth in Table 3.

TABLE 3

| | Impact | | | | Puncture |
|---|---|---|---|---|---|
| Sample | Resistance | Penetration | Elongation | Modulus | Depth |
| ID | (lbf) | (Yes/No) | (%) | (psi) | (in) |
| A | 5.70 | No | 973.80 | 6088 | 4.44 |
| E | 5.10 | Yes | 1656.80 | 78067 | 2.36 |
| F | 2.90 | Yes | 1007.10 | 53158 | 2.11 |
| G | 2.60 | Yes | 1176.10 | 55856 | 1.16 |

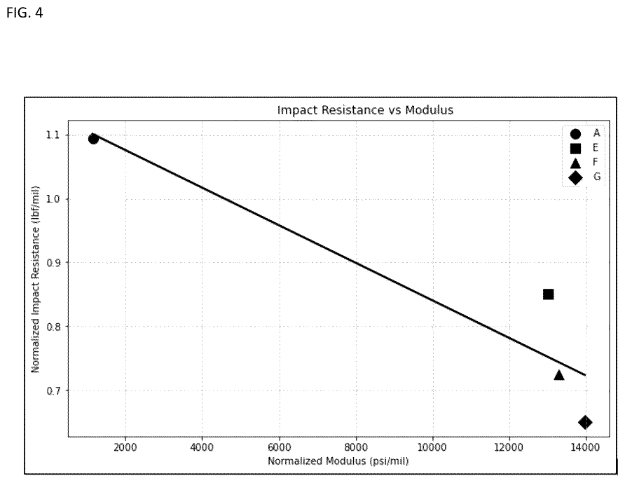

The results plot shown in FIG. 4 is a graphical illustration of the relationship between normalized impact resistance (lbf/mil) (y-axis) and normalized modulus (psi/mil) (x-axis). The correlation coefficient of 0.93 indicates a strong negative correlation, suggesting that as the normalized modulus increases, the normalized impact resistance decreases. This trend implies that materials with higher modulus, which are stiffer and more resistant to deformation, tend to have lower impact resistance, indicating a trade-off between stiffness and the ability to absorb energy from impacts.

### Example 4—Strongly Correlated with Puncture Depth

The Spencer Impact Test (ASTM D5748) was used to assess the puncture resistance of the samples, each with a size of 4.0 inches. The test involved a weighted pendulum and an air clamp assembly set to a minimum of 60 PSI. The pendulum was released from a specific height to strike the test specimen, measuring the energy absorbed upon impact. This method evaluates the toughness and durability of the material by determining its ability to withstand sudden forces. The pendulum height was calibrated to ensure consistent energy delivery across all tests. The data resulting from the tests conducted on the film of each sample is set forth in Table 4.

TABLE 4

| | Impact | | | | Puncture |
|---|---|---|---|---|---|
| Sample | Resistance | Penetration | Elongation | Modulus | Depth |
| ID | (lbf) | (Yes/No) | (%) | (psi) | (in) |
| A | 5.70 | No | 973.80 | 6088 | 4.44 |
| E | 5.10 | Yes | 1656.80 | 78067 | 2.36 |
| F | 2.90 | Yes | 1007.10 | 53158 | 2.11 |
| G | 2.60 | Yes | 1176.10 | 55856 | 1.16 |

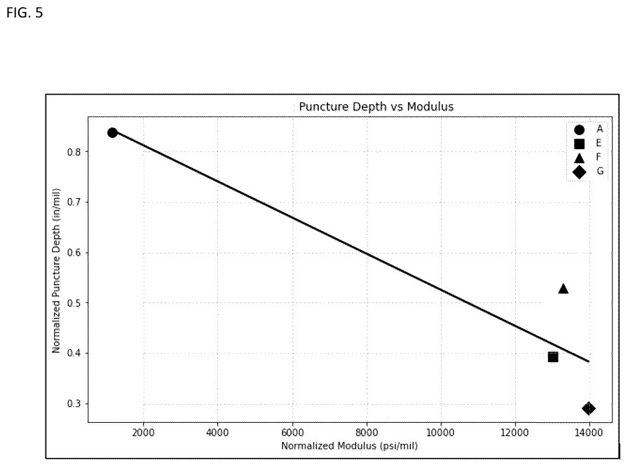

The results plot of FIG. 5 is a graphical illustration of the relationship between normalized puncture depth (y-axis) and normalized modulus (x-axis). The correlation coefficient of 0.93 indicates a strong negative correlation, suggesting that as normalized modulus increases, normalized impact resistance decreases. Despite the p-value of 0.072 being slightly above the conventional threshold for statistical significance (0.05), the data suggests a strong statistical significance.

### Example 5—Strongly Correlated with Pliability Failure Time

Pliability testing involved a setup using 2″×4″ tape samples. The device consisted of two 4″×4″ OSB boards connected via a hinge, with the tape applied across the seam between the boards. The ability of the tape to stretch and retract under hand-applied force was observed, particularly noting any retraction from the plates. A timer was used to measure the time until seam failure occurred. The data resulting from the tests conducted on the film with adhesive for each sample is shown in Table 5.

TABLE 5

| | | | Pliability | |
|---|---|---|---|---|
| | Tape | Hydrostatic | Failure | Seam |
| Sample | Curvature | Head Force | Time | Separation |
| ID | Conformity | (psi) | (sec) | Strain (in) |
| A | Pass | 2 | 25 | 0.33 |
| E | Fail | 11 | 4 | 0.24 |
| F | Fail | 7 | 5 | 0.25 |
| G | Fail | 7 | 6 | 0.24 |

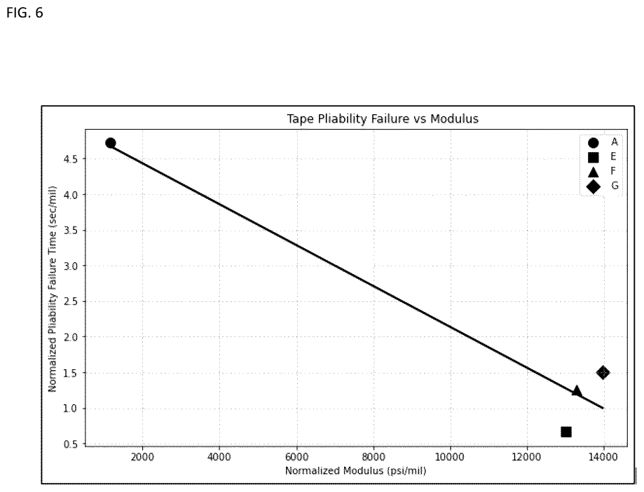

The results are depicted in FIG. 6. FIG. 6 is a graphical illustration showing a strong negative correlation between normalized pliability failure time (y-axis) and normalized modulus (x-axis), as indicated by a correlation coefficient of 0.97 and a p-value of 0.032. This suggests that as the modulus of the material increases, its pliability decreases, demonstrating that stiffer materials tend to have lower pliability. The statistically significant p-value indicates that this relationship is unlikely to be due to random chance. The data highlights the trade-off between stiffness and pliability, which is crucial for applications requiring flexible materials that can conform to irregular surfaces.

### Example 6—Strongly Correlated with Hydrostatic Head Force

The hydrostatic head tester was used to evaluate the water resistance of the samples. The test setup involved applying pressure up to 5 bar on a specimen size of 100 cm², following the AATCC 127 standard. This method measures the ability of the film to resist water penetration under increasing pressure. The test continues until water penetrates the film or reaches the maximum test pressure. The results provided a quantitative measure of the material's water resistance capability, which is crucial for applications requiring waterproof materials.

The results the tests conducted on the film with adhesive for each sample is shown in Table 6.

TABLE 6

| | | | Pliability | |
|---|---|---|---|---|
| | Tape | Hydrostatic | Failure | Seam |
| Sample | Curvature | Head Force | Time | Separation |
| ID | Conformity | (psi) | (sec) | Strain (in) |
| A | Pass | 2 | 25 | 0.33 |
| E | Fail | 11 | 4 | 0.24 |
| F | Fail | 7 | 5 | 0.25 |
| G | Fail | 7 | 6 | 0.24 |

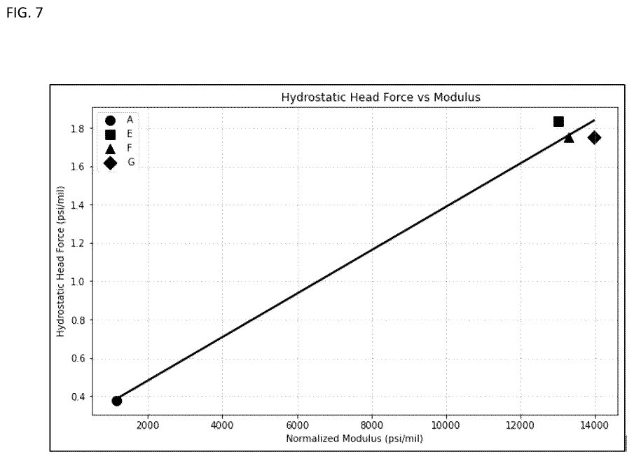

FIG. 7 is a graphical illustration of the relationship between hydrostatic head force (y-axis) and normalized modulus (x-axis). As shown in FIG. 9, the results indicated a very strong positive correlation between hydrostatic head force (y-axis) and normalized modulus (x-axis), with a correlation coefficient of 0.99 and a p-value of 0.006. The near-perfect correlation suggests a significant and consistent relationship between the tested parameters. This implies that as one property increases, the other consistently increases as well. The low p-value indicates that the correlation is statistically significant, meaning the observed relationship is unlikely due to random variation and likely represents a true underlying trend.

### Example 7—Strongly Correlated with Tape Curvature Conformity

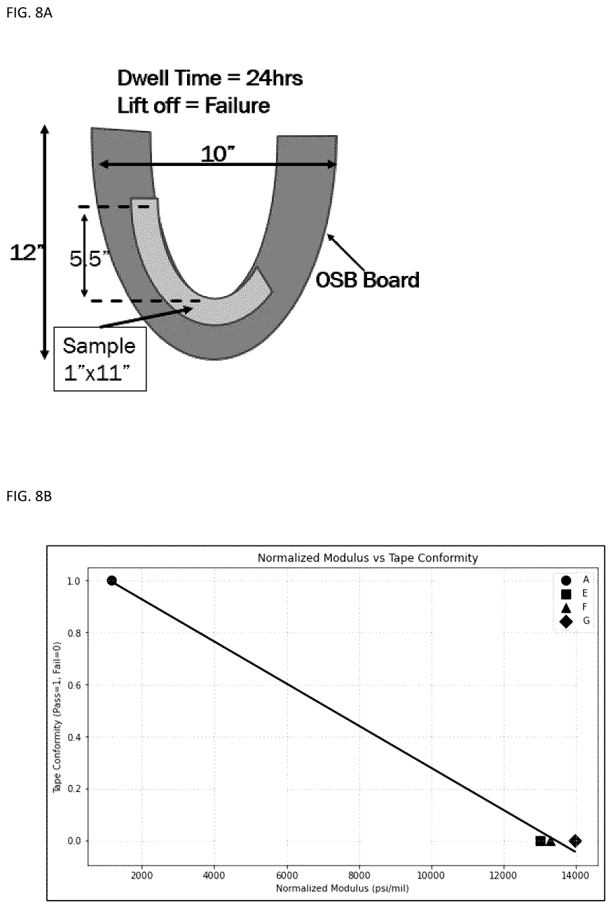

The curvature conformity test was conducted using a U-shaped fixture, with dimensions of 10″ by 12″ as illustrated in FIG. 8A. The test involved applying a 1″×11″ adhesive-coated tape to the curvature conformity tester. The tape was pressed with a 4.5-pound roller twice to ensure proper adhesion. After being allowed to dwell for 24 hours, the tape was observed for any separation from the board. This test measures the tape's ability to conform to curved surfaces without detaching.

The results of the tests conducted on the film with adhesive for each sample is shown in Table 7.

TABLE 7

| | | | Pliability | |
|---|---|---|---|---|
| | Tape | Hydrostatic | Failure | Seam |
| Sample | Curvature | Head Force | Time | Separation |
| ID | Conformity | (psi) | (sec) | Strain (in) |
| A | Pass | 2 | 25 | 0.33 |
| E | Fail | 11 | 4 | 0.24 |
| F | Fail | 7 | 5 | 0.25 |
| G | Fail | 7 | 6 | 0.24 |

The results plot shown in FIG. 8B is a graphical illustration of the relationship between tape conformity (y-axis) and normalized modulus (x-axis). The correlation coefficient of 0.99 suggests a very strong negative correlation, indicating that as the normalized modulus increases, tape conformity/normalized adhesion decreases. The p-value of 0.002 further supports the statistical significance of this correlation, confirming that the observed relationship is unlikely to be due to random chance. This trend implies that tapes with higher modulus, which are stiffer, tend to have lower adhesion, highlighting a trade-off between stiffness and the ability to maintain adherence to curved surfaces.

### Example 8—Shear Tests and Peel Adhesion

A synergy achieved between the film of the backing layer and the adhesive of the adhesive layer of the tape was illustrated by the following test results.

Shear testing of Pressure Sensitive Adhesives (PSAs) on steel was used to measure the ability of the adhesive to resist shear forces under a load, as specified in standards like ASTM D3654. In this test, a PSA tape or film was applied to a steel substrate and a weight of 2.2 pounds (per ASTM D3654) was attached to exert a constant force in a direction parallel to the adhesive bond. The test evaluated the time it took for the adhesive to fail (usually through sliding or detachment) under this specific shear load. This is crucial for applications where the adhesive must hold materials in place under continuous stress. The performance was typically reported in terms of shear holding time (in minutes).

Lap shear testing of Pressure Sensitive Adhesives (PSAs) on polymer films was used to measure the ability of the adhesive to resist shear forces in a lap joint configuration. In this test, two polymer film substrates were bonded with the PSA over a defined overlap area of 1 inch and 2.2 pounds of weight were allowed to exert force, until failure. Compared to regular shear testing, this method tests the adhesive's ability to withstand shear force against its own backing instead of the stainless steel.

Hot shear testing at 65° C. was used to evaluate the ability of the adhesive to resist shear forces under heat, as outlined in standards like ASTM D3654. In this test, a PSA was applied to a steel substrate, and a weight of 1.1 pounds was attached to exert a constant shear force parallel to the adhesive bond. The test was conducted in an oven set to 65° C. to assess the performance of the adhesive under thermal stress. Unlike standard shear testing at room temperature, hot shear testing simulated real-world conditions where the adhesive was exposed to elevated temperatures, which can weaken the bond. The results were typically reported as the time to failure, providing insight into the durability of the adhesive under heat and shear simultaneously.

The Shear Adhesion Failure Temperature (SAFT) test was used to measure the temperature at which the adhesive bond failed under a constant shear load, simulating the performance of the adhesive in high-temperature environments. In this test, a PSA was applied to a substrate, and a weight of 2.2 pounds was attached to exert a constant shear force parallel to the adhesive bond. The test was conducted in a controlled environment where the temperature gradually increased, at a rate of 0.4° C. per minute, until the adhesive bond failed. SAFT was important for understanding the temperature limits of PSAs, particularly for applications exposed to heat. Unlike static shear tests conducted at a fixed temperature, SAFT provided insight into the performance of the adhesive as the temperature rose, with results typically reported as the failure temperature in degrees Celsius.

90-degree Peel Adhesion test at 0° F. was used to evaluate the adhesion strength of Pressure Sensitive Adhesives (PSAs) under low-temperature conditions. In this test, a PSA was applied to the substrate (OSB) and then conditioned at 0° F. for 24 hours. A tensile testing machine was used to peel the adhesive away from the substrate at a 90-degree angle at a constant rate of 2 inches/min. The force required to peel the adhesive was measured and reported as peel adhesion strength, in pound-force per inch (lbf/in). Unlike standard peel tests conducted at room temperature, this test simulated PSA performance in cold environments, providing insights into how the adhesive bond holds up under low-temperature conditions, which can make adhesives more brittle and affect bond strength. Adhesive wettability, which a softer, more conformable substrate can enhance, played a critical role in achieving higher adhesion. A conformable substrate can help the adhesive to better wet the surface and penetrate into surface irregularities, allowing for more complete contact with the surface, which enhances bond strength. Additionally, this increased conformability reduced the potential for the assembly to become brittle at cold temperatures, as the softer structure can better accommodate the stresses induced by low temperatures without fracturing or losing adhesion.

Acrylic adhesive performed particularly well in cold temperatures compared to other adhesive types. Acrylic retained its softness and conformability even at freezing temperatures, which enhanced its wettability—allowing the adhesive to spread and adhere more effectively to irregular surfaces like OSB. This ability to maintain flexibility helped prevent the adhesive from becoming brittle, ensuring a stronger bond in cold environments.

Sample Tape A was a tape having an acrylic-based adhesive of 5 mils with a backing film of 5 mils and having a total thickness of 10 mils (film: PO/EL/PO) in accordance with the invention.

Comparative Tape 1 was a tape having an acrylic adhesive of 5 mils with a backing film of 5 mils and having a total thickness of 10 mils (film: PO/EL/PO).

Comparative Tape 2 was a tape having an acrylic adhesive layer of 7.5 mils and a backing film of 3.5 mils, having a total thickness of 11 mils (film: PO/PO/PO).

Comparative Tape 3 was a tape having a butyl rubber adhesive of 15.1 mils with a backing film of 5.8 mils and a total thickness of 20.9 mils (film: PO/PO/PO).

Results of the Tests were set forth in the Table 8 below:

TABLE 8

| | | | | | 90 Degree |
|---|---|---|---|---|---|
| | | | | | Peel |
| | Shear to | | | | Adhesion |
| | Steel | Lap Shear | Hot Shear | | @ 0F - |
| | @ RT | @ RT | @ 65° C. | SAFT | OSB |
| Sample Name | (min) | (min) | (min) | (° C.) | (oz/in) |
| Sample Tape A | 258 | 50 | 140 | 99 | 36 |
| Comparative | 20 | 31 | 13 | 40 | 22 |
| Tape 1 | | | | | |
| Comparative | 21 | 22 | 4 | 40 | 12 |
| Tape 2 | | | | | |
| Comparative | 6 | 8 | 2 | 40 | 9 |
| Tape 3 | | | | | |

The following observations were made as to Table 8.

Sample Tape A outperformed the other tapes across all test methods, making it the most reliable adhesive in various conditions, including room temperature, elevated temperatures, and low temperatures. The data suggested that for applications involving high temperatures or cold environments, Sample Tape A was the most robust choice, as its high level of conformability allowed it to maintain bond integrity even under challenging conditions. In contrast, the other tapes appeared to lack the necessary conformability and flexibility to perform well in extreme temperatures, making it more suitable for controlled environments where minimal surface irregularities and temperature fluctuations are expected.

Sample Tape A demonstrated superior performance in the 90-degree peel adhesion test at 0° F., particularly on OSB (Oriented Strand Board), which is known for its rough and uneven surface. This strong performance in cold temperatures was attributed to the tape's ability to conform well to irregular surfaces like OSB, ensuring a more complete bond even in challenging conditions. At low temperatures, Sample Tape A retained flexibility and conformability, allowing it to adhere effectively even when exposed to cold environments. It was concluded that this is especially valuable in applications where surface texture and cold temperatures could otherwise compromise adhesion.

Sample Tape A exceled in shear performance due to its highly conformable backing and synergistic acrylic adhesive, which allow it to effectively conform to irregular surfaces by filling in peaks and valleys, enhancing surface contact through wetting-induced bonding. This combination resulted in stronger, more resilient bonds under stress. However, despite similar construction, Comparative Tape 1 lacked this synergy and therefore underperformed. Comparative Tape 2 had a performance that lagged behind Sample Tape A. Comparative Tape 2 had a thicker adhesive layer, but the imbalance in adhesive-to-backing thickness limited its ability to distribute stress effectively. Comparative Tape 3 performed poorly in shear, heat, and cold tests. Comparative Tape 3, with its rigid butyl rubber adhesive and thick backing, performed the weakest, as it lacked the flexibility needed for effective surface wetting and bonding on uneven surfaces.

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements.

What is claimed is:

1. An adhesive tape comprising:
a backing layer,
an adhesive layer on the backing layer, and
an optional liner on the adhesive layer,
wherein the backing layer comprises a film which resists penetration by having an impact resistance >5.5 lb force and a puncture depth of >3 in.

2. The adhesive tape according to claim 1, wherein the adhesive comprises an acrylic.

3. The adhesive tape according to claim 1, wherein the adhesive tape is weatherproof, chemical resistant, or both.

4. The adhesive tape according to claim 1, wherein the adhesive tape is self-wound.

5. The adhesive tape according to claim 1, wherein the film is multilayer.

6. The adhesive tape according to claim 5, wherein the film has distinct elastomeric and polymeric components in each layer of the multilayer film.

7. The adhesive tape according to claim 5, wherein the multilayer film has at least two skins and a core.

8. The adhesive tape according to claim 1, wherein the adhesive tape has a tensile strength in a range of 5 lbf to 15 lbf.

9. The adhesive tape according to claim 1, wherein the adhesive tape is UV resistant.

10. The adhesive tape according to claim 1, wherein the adhesive tape is repositionable.

11. The adhesive tape according to claim 1, wherein the adhesive tape has a total thickness in a range of 6 mils to 23 mils.

12. The adhesive tape according to claim 1, wherein the backing layer has a thickness is in a range of 3 mils to 15 mils.

13. The adhesive tape according to claim 1, wherein the adhesive layer has a thickness is in a range of 3 mils to 8 mils.

14. The adhesive tape according to claim 1, wherein the backing layer is embossed.

15. The adhesive tape according to claim 1, wherein the adhesive tape is opaque.

16. An adhesive tape comprising:
a backing layer,
an adhesive layer on the backing layer, and
an optional liner on the adhesive layer,
wherein the backing layer comprises a film having an elongation and a modulus in a relationship as set forth in equation (1):
$$y = mx + b \qquad equation ( 1 )$$
wherein
m is slope,
b is y-intercept,
x is a normalized elongation (%/mil) as defined by x₁ and x₂,
wherein
x₁ (%/mil) is at least 180 to 1400;
x₂ (%/mil) is at least 180 to 1400; and
y is a normalized modulus (psi/mil) having a range of y_{MIN} to y_{MAX}
wherein
$${y}_{MIN} = - 21432.4 + {1204}_{{X}_{1}}$$
$${y}_{MAX} = - 17020.6 + {1204}_{{X}_{2}} .$$

17. The adhesive tape according to claim 16, wherein the adhesive comprises an acrylic.

18. The adhesive tape according to claim 16, wherein the adhesive tape is weatherproof, chemical resistant, or both.

19. The adhesive tape according to claim 16, wherein the adhesive tape is self-wound.

20. The adhesive tape according to claim 16, wherein the film is multilayer.

21. The adhesive tape according to claim 20, wherein the film has distinct elastomeric and polymeric components in each layer of the multilayer film.

22. The adhesive tape according to claim 20, wherein the multilayer film has at least two skins and a core.

23. The adhesive tape according to claim 16, wherein the adhesive tape has a tensile strength in a range of 5 lbf to 15 lbf.

24. The adhesive tape according to claim 16, wherein the adhesive tape is UV resistant.

25. The adhesive tape according to claim 16, wherein the adhesive tape is repositionable.

26. The adhesive tape according to claim 16, wherein the adhesive tape has a total thickness in a range of 6 mils to 23 mils.

27. The adhesive tape according to claim 16, wherein the backing layer has a thickness is in a range of 3 mils to 15 mils.

28. The adhesive tape according to claim 16, wherein the adhesive layer has a thickness is in a range of 3 mils to 8 mils.

29. The adhesive tape according to claim 16, wherein the backing layer is embossed.

30. The adhesive tape according to claim 16, wherein the adhesive tape is opaque.
